(19) United States
(12) Patent Application Publication
(10) Pub. No.: US 2008/0041895 A1
(43) Pub. Date: Feb. 21, 2008

(54) Liquid dispensing system for vehicles and the like

(76) Inventor: Kenneth L. Hall, Orange City, FL (US)

Correspondence Address: EDWARD M. LIVINGSTON, PA, 963 TRAIL TERRACE DRIVE, NAPLES, FL, 34103, US

(21) Appl. No.: 11/504,321

(22) Filed: Aug. 15, 2006

(51) Int. Cl. G04C 1/12; B60P 3/22

(52) U.S. Cl. 222/640; 222/608

(57) ABSTRACT

A liquid dispensing system has a liquid-holding container 1 connected to a dispensing station 2 by a conduit 3. A pump 4 in the conduit 3 is activated by a switch 10 at the dispensing station 2 which causes liquid to pass from the container 1 though the conduit 3 and out a spigot 11 at the dispensing station 2. The dispensing station 2 may have a timer switch 17 to release a pre-determined amount of liquid. The system may be powered by a 12 volt electrical source typical of most vehicles or by 110 volt power from a receptacle.

### BACKGROUND OF THE INVENTION

This invention relates to liquid dispensing systems and more particularly to a liquid dispensing system for a vehicles and the like, capable of dispensing cold and hot liquids and mountable in the vehicle at a location readily accessible to the driver and/or passengers.

Persons who must drive a vehicle for long periods of time, particularly when a person's occupation requires it, such as postal workers and those working for delivery services, or even persons involved in time-consuming recreational activities, such as golf, require liquid replenishment on a consistent basis, especially in hot weather. The vehicles driven by many such workers are not air conditioned thereby increasing the need for liquid replenishment even further. On the other hand, in cold conditions, such persons may desire hot liquids such as coffee. In addition to needing liquid refreshment in a vehicle, such persons and others who may work in offices would like to have a system that is portable and that could be filled with the liquid of choice and be usable in all locations.

Thus the need exists for a vehicle system that will provide liquid replenishment for persons in a vehicle or other locations upon demand.

The prior patented art includes the following patents:

| U.S. Pat. No. | | |
|---|---|---|
| (U.S. unless stated otherwise) | Inventor | Issue Date |
| 4,034,571 | Bollinger | Jul. 12, 1977 |
| 4,342,202 | Knutson | Aug. 03, 1982 |
| 3,642,023 | Rembert | Feb. 15, 1972 |
| 4,140,150 | Rundell | Feb. 20, 1979 |
| 5,497,918 | Brilanchik | Mar. 12, 1996 |
| 3,558,013 | Ponzo et al. | Jan. 26, 1971 |
| 6,076,706 | Kritchman | Jun. 20, 2000 |
| 4,130,145 | Thomas, Jr. | Dec. 19, 1978 |
| 6,460,361 | Faria | Oct. 08, 2002 |

Although some of the above prior art discloses liquid dispensing systems for vehicles, none discloses a system like the present invention.

### SUMMARY OF THE INVENTION

The primary object of the present invention is to provide a liquid dispensing system for vehicles that provides liquid replenishment upon demand.

Another object is to provide such a system that is powered by a vehicle's electrical system.

An even further object of the present invention is to provide a dispensing system that is portable so that it can be used in locations other than vehicles.

Another object of the present invention is to provide such a dispensing system that has a dispensing station that can be mounted on the dash or the desired location in a vehicle for ready access to driver and/or passengers.

An even further object of the present invention is to provide a dispensing system that dispenses a pre-set desired amount of liquid.

Even another object of the present invention is to provide such a system for the dispensing switch that is lighted for visibility in darkened conditions.

The present invention fulfills the above and other objects for providing a liquid dispensing system for vehicles and the like having a liquid container which is connected to a dispensing station by a conduit from the container to the dispensing station. A pump motor in the conduit is located near the bottom of the container so when a switch on the dispensing station is activated, the system will pump liquid through the conduit from a spigot into a drinking vessel. The system can be electrically powered by being connected to a 12 volt down source, a 110 power source or DC battery power pack. The dispensing switch at the dispensing station may contain a light for easy visibility in dark conditions. The dispensing switch may also contain a timer control so that one push and immediate release of the switch would dispense a pre-set desired amount of liquid.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the liquid dispensing system of the present invention;

FIG. 2 is a side cutaway view of the liquid dispensing system of the dispensing station of the present system;

FIG. 3 is a partial side cutaway of the liquid container and pump motor connection of the present invention; and

FIG. 4 is a partial cutaway of an optional 110 volt power source usable with the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | liquid container |
| 2. | dispensing station |
| 3. | liquid conduit |
| 4. | pump |
| 5. | container bottom |
| 6. | container walls |
| 7. | container top |
| 8. | container vacuum button |
| 9. | light on the dispensing switch |
| 10. | dispensing switch |
| 11. | dispensing spigot |
| 12. | dispensed liquid |
| 13. | cup |
| 14. | pump electrical wires |
| 15. | wires to power source |
| 16. | 12 v plug |
| 17. | dispensing switch controls |
| 18. | liquid in container |
| 19. | diaphram |
| 20. | plug insert |
| 21. | 110 v transformer |
| 22. | 110 plug |
| 23. | DC battery pack |

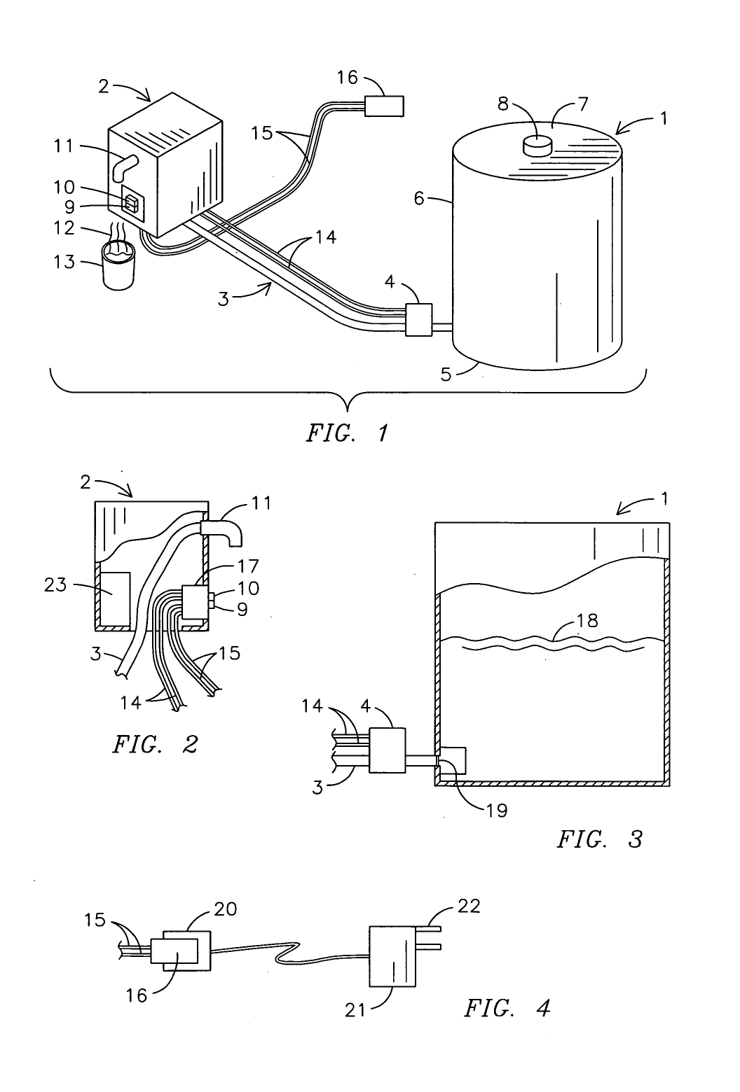

Referring to FIG. 1 the entire liquid dispensing system of the present invention is shown in perspective view. The liquid container 1 is connection by a liquid conduit 3 made of transparent plastic to the dispensing station 2. A pump 4 is located near the liquid container 1 proximate the bottom 5. The pump 4 is electrically connected to the dispensing station 2 by wires 14, all of which may be wrapped together with the liquid conduit 3 by an insulated covering. The electrical wires 14 connect electrically to the switch 10 which in turn is electrically connected by wires 15 to a 12 volt plug 16 which may be inserted into the power output jack of a motor vehicle. Optionally, the system could be powered by a DC battery pack 23 housed within the dispensing station 2.The liquid container 1 would have a bottom 5, walls 6 and a top 7 to form an aperture inside the container for the storage of liquid. A vacuum button 8 on the top of the liquid container 1 would enable the container 1 to allow liquid to be removed via the pump 4 and still maintain a vacuum within the container 1 so when pumping of the liquid from the spigot 11 on a dispensing station 2 is finished, the vacuum within the container 1 would cause any liquid in the conduit 3 to be returned to the container, thereby preventing any stale liquid from being stored in the conduit 3. The on/off switch 10 of the dispensing station 2 would preferable have a light 9 which would be visible in darkened conditions. When the dispensing switch 10 is pushed it would discharge the liquid 12 from the spigot 11 into a drinking vessel, such as a cup 13. Although the spigot 11 extends from the dispensing station 2 it may be made flush-mounted if desired.

FIG. 2 shows a side cutaway view of the dispensing station 2 which shows the internal components of the dispensing station 2. In addition to the, the dispensing switch 10 and spigot 11, the dispensing station 2 also has internal controls 17 which are electrically connected to power source 15 and to the pump 4 via electrical wires 14. The dispensing switch controls 17 may contain a timer so that the switch 10 can be pushed once and immediately released, so as to dispense a pre-set amount of liquid, such as 4 to 8 oz depending on the size of the cup 13. In this manner a user would not have to take his/her eyes off the road while driving to look at a cup to see when it is nearly full.

FIG. 3 shows a cutaway section of the liquid container 1 and its connection with the liquid conduit 3. The liquid 12 would be pumped from the container 1 outlet through a diaphragm 19 by the pump 4 electrically connected to the dispensing switch 10 by wires 14. The diaphragm 19 would preferably be made of silicon and would stop water from moving through and into the conduit line 3 until the pump motor 4 has been activated. The liquid container 1 may be insulated and come in various sizes such as 1, 2 and 5 gallons. The liquid container 1 could be mounted in a motor vehicle behind the front seats and the dispensing station 2 could be attached to a dash or other location easily accessible to a driver or passengers or even to the outside of a vehicle for access to workers, campers and so forth. The liquid container 1 could also be a soft-side cooler that is strapped to the back of a seat.

In FIG. 4 an alternative 110 volt system for the dispensing system is disclosed. Although preferably the dispensing system will be powered from a 12 volt power outlet by inserting the male 12 volt plug 16 into the power outlet of a motor vehicle, it also could be powered by 110 volts by plugging the 12 volt plug 16 into a 110 volt female plug 20 electrically connected to a 110 transformer 21 with prongs 22 for insertion into a standard 110 electrical receptacle. Moreover, the dispensing; system could be electrically connected to a 12 volt battery of a vehicle, especially in situations where a 12 volt power plug is not in a vehicle, such as a golf cart. As the liquid dispensing system could be made portable rather than permanently mounted in a motor vehicle, the capability of operating on 110 volts would also make it usable in an office setting as well.

Although only a few embodiments of the present invention have been described in detail hereinabove, all improvements and modifications to this invention within the scope or equivalents of the claims are included as part of this invention.

Having thus described my invention, I claim:

1. A liquid dispensing system for vehicles and the like comprising:
a liquid container having a bottom floor, a top cover and peripheral walls surrounding said bottom floor so as to create a aperture between said bottom, top and peripheral walls for holding liquid;
a liquid conveying conduit extending from a peripheral wall proximate the bottom of the container and connected to a dispensing station at an opposite end;
a dispensing station connected to the liquid conveying conduit to the opposite end and having a spigot at the opposite end for discharging liquid into a drinking vessel;
a liquid pump motor in the conduit proximate the container for pumping liquid from the container when a switch on the dispensing station is activated;
a dispensing switch on the dispensing station for activating the liquid pump motor when desired to dispense liquid from the spigot; and
a power source electrically connected to the dispensing switch and pump motor.

2. The liquid dispensing liquid dispensing system of claim 1 wherein the liquid container has a vacuum button on the top cover.

3. The liquid dispensing system of claim 1 wherein the liquid container is mounted within a motor vehicle.

4. The liquid dispensing system of claim 1 wherein the dispensing switch contains a light that is visible in dark conditions.

5. The liquid dispensing system of the claim 1 wherein the dispensing switch has timer controls which can be pre-set to operate the pump motor for specified period of time to dispense a pre-determined amount of liquid.

6. The liquid dispensing system of claim 1 wherein the dispensing station is mounted on the dash of a motor vehicle;

7. The liquid dispensing system of claim 1 wherein the power source is a 12 volt vehicle power source.

8. The liquid dispensing system of claim 1 wherein the power source is a 110 volt household electrical system.

9. The liquid dispensing system of claim 1 wherein the power source is a DC battery pack housed within the dispensing station.

10. The liquid dispensing system of claim 1 wherein the liquid container is connected to the liquid conduit by a diaphram to prevent liquid from leaving the container when the pump motor is not activated.
